(19) United States
(12) Patent Application Publication
(10) Pub. No.: US 2005/0211232 A1
(43) Pub. Date: Sep. 29, 2005

(54) Valve arrangement, closed crankcase system, and methods

(76) Inventors: Robert Allen Dushek, Bloomington, MN (US); Steven Scott Gieseke, Richfield, MN (US)

Correspondence Address: Merchant & Gould P.C., P.O. Box 2903, Minneapolis, MN, 55402-0903, US

(21) Appl. No.: 10/812,775

(22) Filed: Mar. 29, 2004

(51) Int. Cl. F02B 25/06

(52) U.S. Cl. 123/574

(57) ABSTRACT

A valve arrangement includes a one-piece piston-diaphragm member. The one-piece piston-diaphragm member includes a connecting rod terminating at a piston head. The piston head defines a relief aperture arrangement extending between oppositely disposed pressure-receiving surfaces. The one-piece piston-diaphragm member includes an adapter with a diaphram molded over the adapter. The diaphragm is oriented to form a seal with the housing, when the valve arrangement is operably installed within a housing. The valve arrangement includes a plate in movable covering relation to the relief aperture arrangement in the piston head. The plate forms a releasable seal arrangement with the relief aperture arrangement. The valve arrangement is useable in a closed crankcase system including an air filter, an engine, and a blow-by filtration system. The valve arrangement is operably installed in the blow-by filtration system downstream of the crankcase to receive blow-by fluid. A method for regulating pressure in a closed crankcase system includes directing blow-by fluid from an engine crankcase to a valve arrangement. The valve arrangement includes a one-piece piston-diaphragm member. The flow of blow-by fluid is controlled through a relief aperture arrangement in a piston head by applying force against a plate to hold the plate in covering relation to the relief aperture arrangement. The flow of blow-by fluid is controlled to downstream components by applying a force against the second pressure-receiving surface of the piston head.

### TECHNICAL FIELD

This disclosure relates to apparatus and methods for regulating pressure in a closed engine crankcase system.

### BACKGROUND

Some engine crankcase systems are closed for pollution control reasons. In engines, blow-by fluids are created by pressure leakage passed piston rings and by reciprocating motion of pistons. A draft tube from the crankcase emits blow-by in the form of aerosol and coalescence droplets. Chemically, these blow-by emissions are in the form of oil droplets, carbon soot, and debris from wear for fugitive dust.

Closed crankcase systems can use a filtration system to clean the blow-by emissions. Cleaned emissions can be routed back into the air intake system of the engine. Excessive variations in crankcase pressure can damages seals and cause a loss of oil.

It would be useful to have a convenient, easily useable valve arrangement to regulate pressure within a closed crankcase system.

### SUMMARY

A valve arrangement is provided including a one-piece piston-diaphragm member. The one-piece piston-diaphragm member includes a connecting rod terminating at a piston head. The piston head defines a relief aperture arrangement extending between oppositely disposed pressure-receiving surfaces. The one-piece piston-diaphragm member includes an adapter with a diaphram molded over the adapter. The diaphragm is oriented to form a seal with the housing, when the valve arrangement is operably installed within a housing. The valve arrangement includes a plate in movable covering relation to the relief aperture arrangement in the piston head. The plate forms a releasable seal arrangement with the relief aperture arrangement.

In another aspect, the disclosure describes a closed crankcase system including an air filter, an engine, a blow-by filtration system, and a valve arrangement. The valve arrangement is operably installed in the blow-by filtration system downstream of the crankcase to receive blow-by fluid. The valve arrangement includes a one-piece piston-diaphragm member.

In another aspect, the disclosure describes a method for regulating pressure in a closed crankcase system. The method includes directing blow-by fluid from an engine crankcase to a valve arrangement. The valve arrangement includes a one-piece piston-diaphragm member. The flow of blow-by fluid is controlled through a relief aperture arrangement in a piston head by applying force against a plate to hold the plate in covering relation to the relief aperture arrangement. The flow of blow-by fluid is controlled to downstream components by applying a force against the second pressure-receiving surface of the piston head.

### BRIEF DESCRIPTION OF THE DRAWINGS

FIG. 1 is a schematic depiction of a closed engine crankcase system, constructed according to principles of this disclosure;

FIG. 2 is a schematic, cross-sectional view of a valve arrangement constructed according to principles of this disclosure, the valve arrangement being depicted along with a blow-by filtration system;

FIG. 3 is a perspective view of a valve arrangement constructed according to principles of this disclosure;

FIG. 4 is a top plan view of the valve arrangement depicted in FIG. 3;

FIG. 5 is a side elevational view of the valve arrangement depicted in FIG. 4;

FIG. 6 is a bottom plan view of the valve arrangement depicted in FIGS. 3-5;

FIG. 7 is a cross-sectional view of the valve arrangement depicted in FIG. 4, the cross-section being taken along the line 7-7 of FIG. 4;

FIG. 8 is a top plan view of an adapter used in the valve arrangement depicted in FIGS. 2-7;

FIG. 9 is a cross-sectional view of the adapter depicted in FIG. 8, the cross-section being taken along the line 9-9 of FIG. 8;

FIG. 10 is a top plan view of a plate used in the valve arrangement depicted in FIGS. 2-7; and

FIG. 11 is a cross-sectional view of the plate depicted in FIG. 10, the cross-section being taken along the line 11-11 of FIG. 10.

### DETAILED DESCRIPTION

A. Overview

Internal combustion engines, such as pressure-charged diesel engines, often generate “blow-by” gases or fluid, i.e., a flow of air-fuel mixture leaking past pistons from the combustion chambers. Such “blow-by fluid” generally comprise a gas phase, for example air or combustion off gases, carrying therein: (a) hydrophobic fluid (e.g., oil including fuel aerosol) principally comprising 0.1-5.0 micron droplets (principally, by number); and, (b) carbon contaminant from combustion, typically comprising carbon particles, a majority of which are about 0.1-10 microns in size. Such “blow-by fluids” are generally directed outwardly from the engine block, through a blow-by vent.

The blow by fluids may carry substantial amounts of other components. Such components may include, for example, copper, lead, silicone, aluminum, iron, chromium, sodium, molybdenum, tin, and other heavy metals.

Engines operating in such systems as trucks, farm machinery, boats, buses, and other systems generally comprising diesel engines, may have significant gas flows contaminated as described above. For example, flow rates and volumes on the order of 2-50 cubic feet per minute (cfm), typically 5 to 10 cfm, are fairly common.

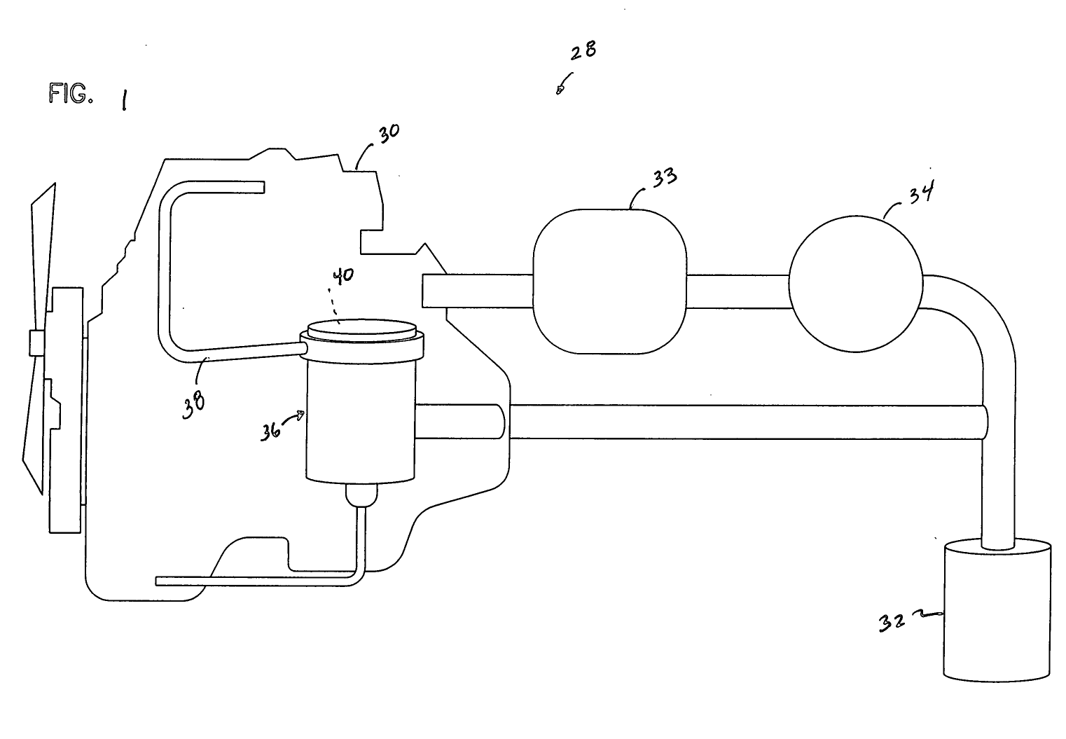

FIG. 1 illustrates a schematic indicating a typical closed crankcase system 28 in which a pressure indicator according to the present invention would be utilized. Referring to FIG. 1, block 30 represents an internal combustion engine, for example, a turbocharged diesel engine crankcase. Air is taken to the engine 30 through an air filter 32. Air filter or cleaner 32 cleans the air taken in from the atmosphere. A turbo 34 draws the clean air from the air filter 32 and pushes it through an after-cooler 33 into engine crankcase 30. While in engine 30, the air undergoes compression and combustion by engaging with pistons and fuel. During the combustion process, the engine 30 gives off blow-by fluid 38. A filtration system 36 is in gas flow communication with engine 30 and cleans the blow-by fluid 38.

Within the system 28, there is a valve arrangement 40. Valve arrangement 40 regulates the amount of pressure in the engine crankcase 30. Valve arrangement 40 opens more and more, as the pressure in the engine crankcase increases, in order to try to decrease the pressure to an optimal level. The valve arrangement 40 closes to a smaller amount when it is desirable to increase the pressure within the engine 30. When air intake system vacuum increases, the valve arrangement 40 closes to prevent the crankcase 30 from reaching larger negative pressures. The valve arrangement 40 automatically adjusts crankcase pressures as the air filter loads and increases the intake system vacuum, and as the blow-by filtration system 36 loads with contaminant and increases the crankcase pressure.

B. Valve Arrangement

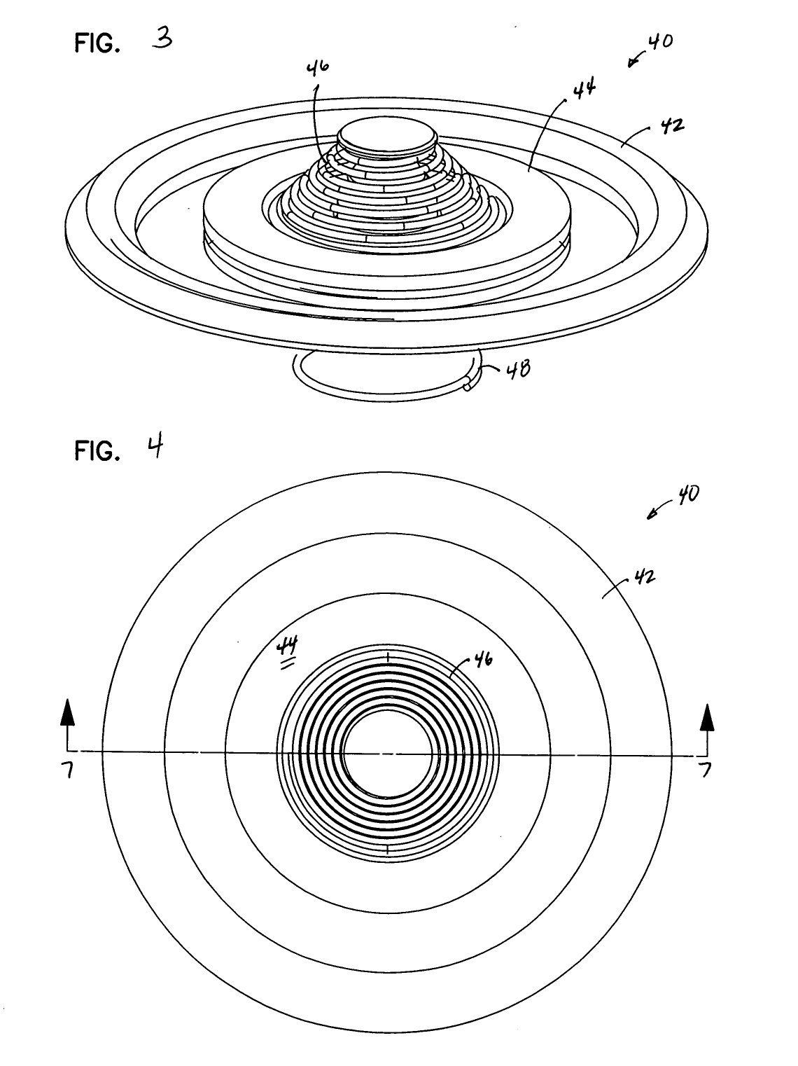

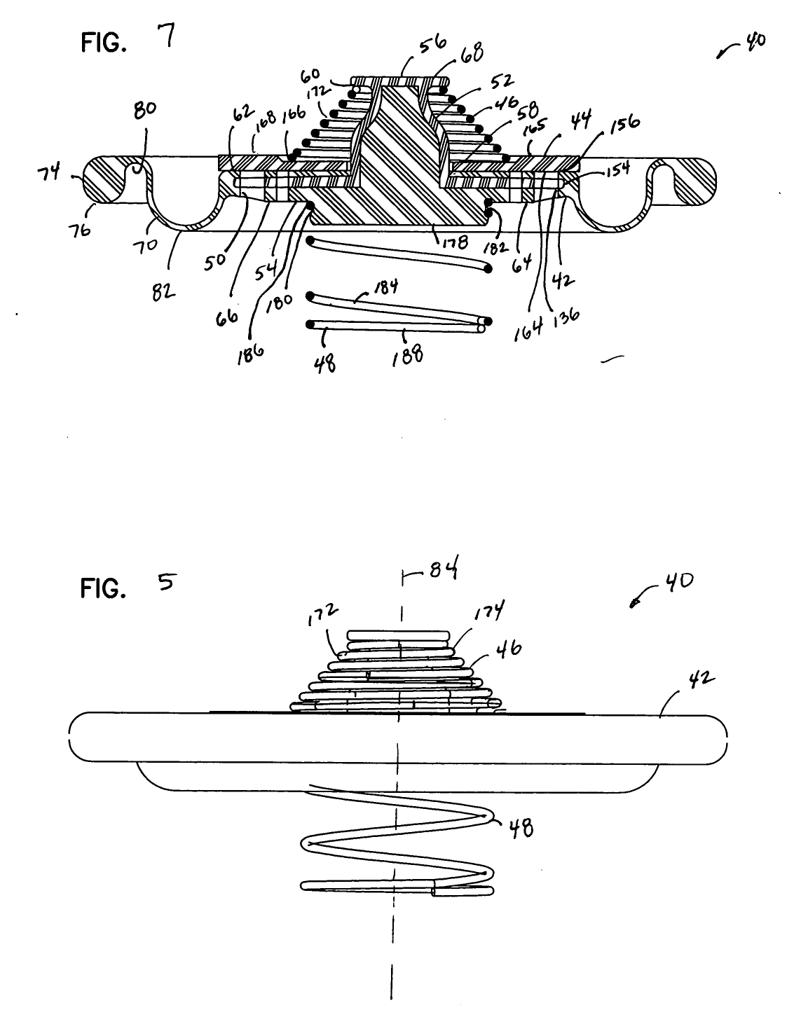

FIG. 3 depicts valve arrangement 40 in perspective view. In FIG. 3, the portions of the valve arrangement 40 that are visible include a one-piece piston-diaphragm member 42, a plate 44, a first biasing member 46, and a second biasing member 48. FIG. 4 shows a top plan view of the valve arrangement 40 depicted in FIG. 3. In FIG. 4, the one-piece piston-diaphragm member 42 can be seen, along with the plate 44, and the first biasing member 46. A bottom plan view is depicted in FIG. 6, in which a relief aperture arrangement 50 is visible extending through the piston-diaphram member 42. The side elevational view in FIG. 5 shows the relationship between the first biasing member 46 and second biasing member 48 on opposite sides of the one-piece piston-diaphragm member 42. Preferable arrangements and functions of these pieces is described further below.

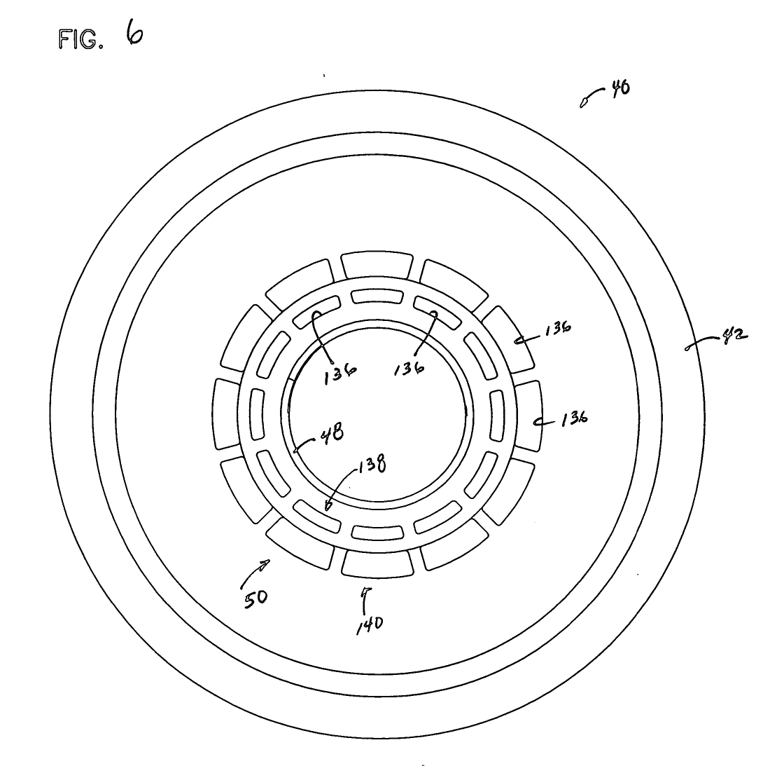

Attention is now directed to FIG. 7. FIG. 7 depicts a cross-sectional view of the valve arrangement 40. In FIG. 7, the one-piece piston-diaphragm member 42 is shown. The one-piece piston-diaphragm member 42 includes a connecting rod 52 and a piston head 54. In the embodiment shown, the connecting rod 52 has a free end 56, and an opposite end 58 that terminates at the piston head 54. The free end 56 of the connecting rod 52 preferably includes a radially extending flange 60. The function of the flange 60 is described further below.

The piston head 54 defines oppositely disposed first pressure-receiving surface 62 and second pressure-receiving surface 64. Surfaces 62 and 64 are constructed and arranged to receive pressure forces and to respond to the pressure forces. This is described further below.

The piston head 54 further defines relief aperture arrangement 50 extending between the oppositely disposed first and second pressure-receiving surfaces 62, 64. The relief aperture arrangement 50 cooperates with the plate 44 to permit the passage of fluids therethrough, when the valve arrangement 40 is acting as a relief valve. The function and operation of the valve arrangement 40 when it is acting as a relief valve is described further below.

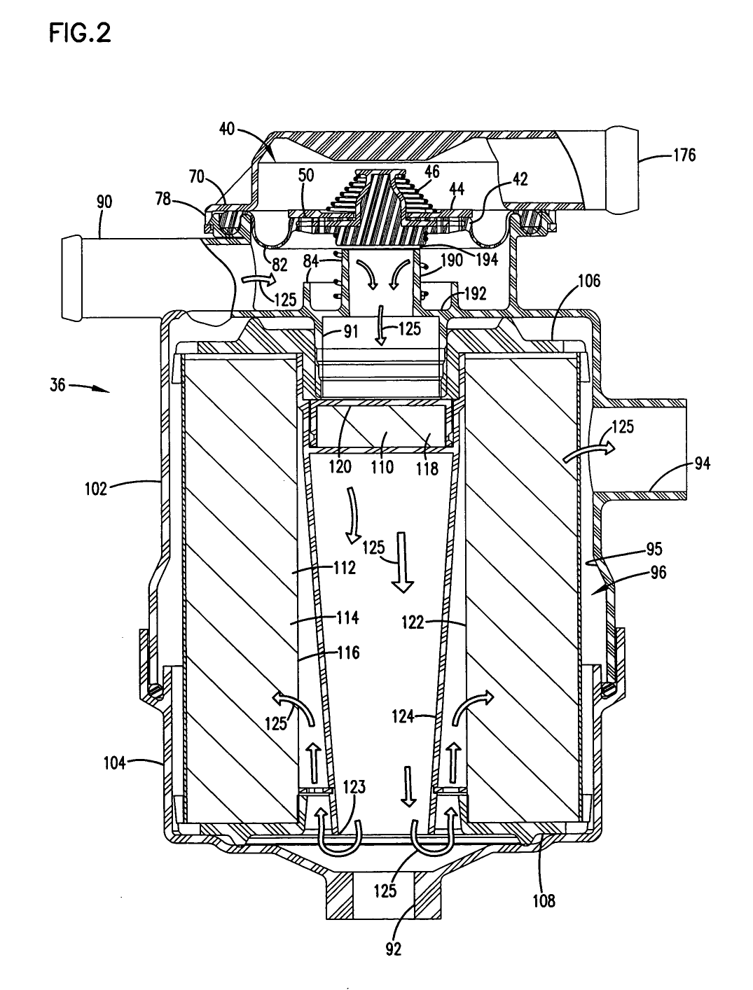

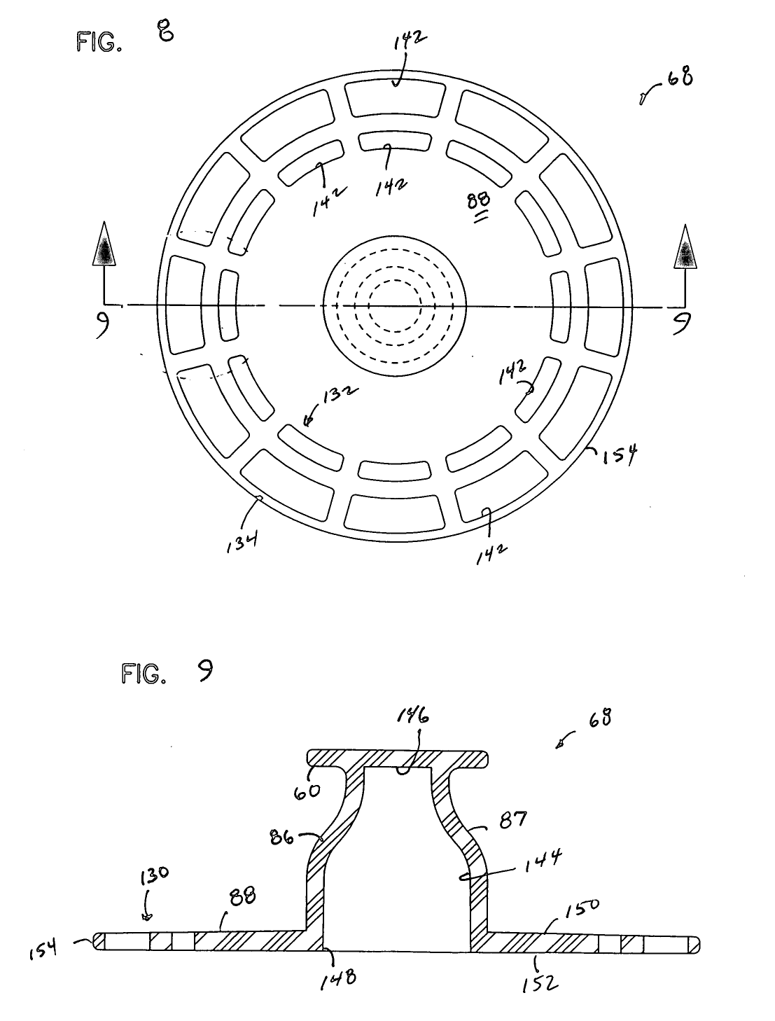

The one-piece piston-diaphragm member 42 is a composite structure 66. The composite structure 66 includes an adapter 68 (FIGS. 8 and 9) and a diaphragm 70 (FIG. 7). In preferred embodiments, the diaphram 70 is molded over the adapter 68. When the valve arrangement 40 is operably installed in a housing, the diaphragm 70 is oriented to form a seal 72 (FIG. 2) with the housing 98.

In preferred embodiments, the diaphragm 70 includes an outer periphery 74. The outer periphery 74 defines a rounded edge 76. In use, the rounded edge 76 fits within a groove 78 in housing 98 to help form the seal 72. Adjacent to the rounded edge 76, the diaphragm 70 defines a recessed groove 80. Adjacent to the recessed groove 80 is a U-shaped flexible portion 82. The U-shaped flexible portion 82 is partially defined by the recessed groove 80. The U-shaped flexible portion 82 extends from the rounded edge 76 to the piston head 54. In use, when the valve arrangement 40 is installed within housing 98 (FIG. 2), the U-shaped flexible portion 82 flexes in response to pressure forces on the piston head 54 to permit the one-piece piston-diaphragm member 62 to move in a direction parallel to a central longitudinal axis 84 (FIG. 5) extending through the valve arrangement 40. The central longitudinal axis 84 is also parallel to the connecting rod 52. In preferred embodiments, the diaphragm 70 is constructed of a flexible material, such as nitrile rubber, having a durometer of 70.

Attention is directed to FIGS. 8 and 9. The adapter 68 is illustrated. In the embodiment shown, the adapter 68 defines an outer exterior surface 86 that defines the exterior of the connecting rod 52. The flange 60 can also be seen. The adapter 68, in the embodiment shown, has an adapter head 88 that forms the portion of the piston head 54. The adapter head 88 has an aperture arrangement 130, which forms part of the aperture arrangement 50 in the one-piece piston-diaphragm member 42. The aperture arrangement 130 includes an inner ring 132 and an outer ring 134 of spaced apertures 142. When the diaphragm 70 is molded over the adapter 68, the resulting aperture arrangement 50 (FIG. 6) also includes an inner ring 138 and an outer ring 140 of spaced apertures 136.

The adapter 68 includes a stem portion 87, and defines an interior volume 144 with a closed end 146 and an open end 148. The adapter head 88 has a first side 150 and an oppositely disposed second side 152. The aperture arrangement 130 extends between the first side 150 and second side 152.

When the diaphragm 70 is molded over the adapter 68, the diaphram material fills the interior volume 144 and covers the first side 150, second side 152, but allows the spaced apertures 142 to remain open to result in the aperture arrangement 50 (FIG. 6). In the preferred embodiment shown, the diaphragm 70 is not molded over the exterior surface 86 of the stem portion 87. Rather, in the embodiment shown, the diaphragm 70 is only molded over and around the head 88 and within the interior volume 144 of the stem portion 87. As can be seen in FIG. 7, the diaphragm 70 extends radially from the outer peripheral edge 154 of the adapter 68.

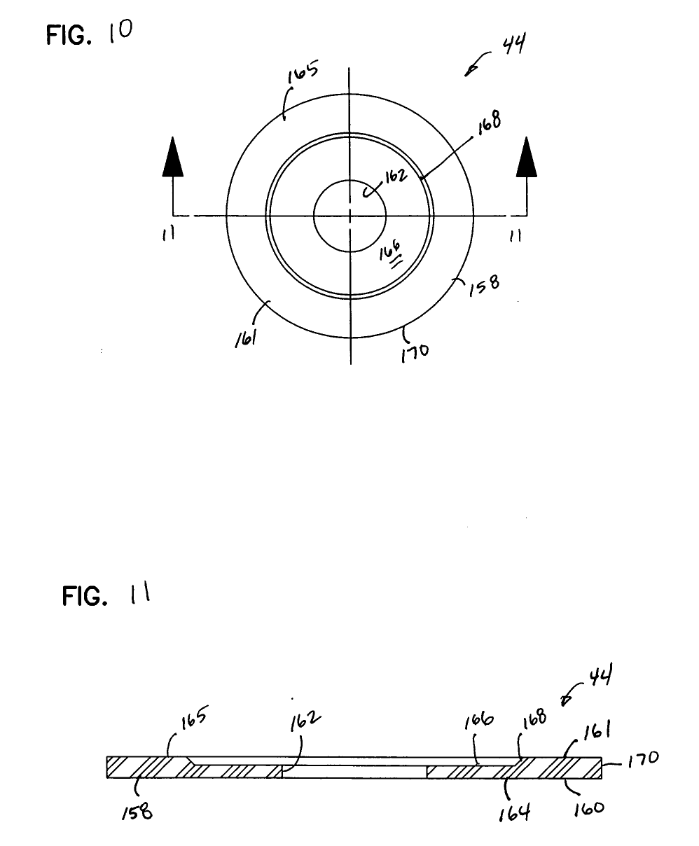

Attention is next directed to FIGS. 10 and 11. The plate 44 is illustrated. The plate 44 is oriented relative to the one-piece piston-diaphragm member 42 such that it is in movable covering relation to the relief aperture arrangement 50 in the piston head 54 to form a releasable seal arrangement 156 (FIG. 7) with the relief aperture arrangement 50. In the embodiment shown in FIGS. 10 and 11, the plate 44 illustrated is a ring 158 defining opposite sides 160, 161, and a central aperture 162. In the embodiment shown, the side 160 is also a piston-head side 164. The opposite side 161 is also a spring-receiving side 165. In FIG. 7, it can be seen how the relief aperture arrangement 50 is exposed to the piston-head side 154 of the plate 44. In use, the plate 44 is movable away from and out of sealing engagement with the relief aperture arrangement 50 in response to pressure forces on the piston-head side 164 of the plate 44 through the relief aperture arrangement 50.

The central aperture 162 of the plate 44 is oriented around and circumscribes the connecting rod 52.

In reference to FIG. 11, the spring-receiving side of the plate 165 defines a spring seat 166 having an axially projecting surface 168. In the embodiment shown, the axially projecting surface 168 extends from an outer edge 170 to the spring seat 166. The function of this can be appreciated by reviewing FIG. 7. In FIG. 7, the first biasing member 46 is oriented such that it is within the spring seat 166. In the particular embodiment shown, the first biasing member 46 is a coiled spring 172 that is oriented between and against the radially extending flange 60 of the connecting rod 52 and the spring seat 166. In the embodiment shown, the spring 172 has an outer cross-sectional shape of a truncated cone 174.

In reviewing FIG. 7, it should now be apparent how the valve arrangement 40 functions as a relief valve. When pressures through the aperture arrangement 50 on the piston-head receiving side 164 of the plate 44 exceed the pressure exerted on the spring-receiving side 165 of the plate 44, the plate 44 is moved against the pressure of the spring 172 in a direction away from the piston head 54. This releases the seal arrangement 156 between the plate 44 and the piston head 54 to allow fluid to flow through the spaced apertures 136 in the piston head 54. In the embodiment of FIG. 2, these fluids that flow through the relief aperture arrangement 50 then exit through a blow-by relief outlet channel 176.

In preferred embodiments, the plate 44 is constructed of a non-metallic material, for example, 33% glass filled nylon, 2 mm thick. This plastic material cooperates with the rubber material of the diaphragm 70 to form the seal arrangement 156.

Attention is again directed to FIG. 7. The piston head 54 defines an axially extending member 178 that also forms a part of the second pressure receiving surface 64. The axially extending member 178, in the embodiment shown, is generally cylindrical in shape, defining a groove 180 in a radial surface 182. The groove 180, in the embodiment shown, is for holding a portion of the second biasing member 48. In the embodiment shown, the second biasing member 48 is a coiled spring 184 with an end 186 that circumscribes the axially extending member 178 and is seated within the groove 180.

In FIG. 2, an opposite end 188 of the spring 184 circumscribes an inlet tube 190 of the housing 98. The end 188 is oriented against a collar 192 of the inlet tube 190.

C. Example of Downstream Component of the Valve Arrangement (Blow-By Filtration System)

An example embodiment of a blow-by filtration system 36 is depicted in a cross-sectional view in FIG. 2. The particular blow-by filtration system 36 described is the type of system described in PCT WO 01/47618, published Jul. 5, 2001, which is incorporated herein by reference.

In the embodiment shown, the blow-by filtration system 36 includes housing 98 with blow-by fluid inlet 90, a liquid outlet 92, and a filtered gas port 94. The filtered gas port 94 is in gas flow communication with the engine 30.

Still in reference to FIG. 2, the blow-by filtration system 36 shown includes a blow-by filter member 95, specifically a two-stage element 96 that is removable and replaceable within housing 98. The housing 98 includes a housing body 102 and a service cover 104 to provide access to the two-stage element 96.

The two-stage element 96 has a first end cap 106 and a second end cap 108. The first end cap 106 circumscribes a blow-by fluid inlet channel 91. There is a first stage coalescer filter 110 that is oriented in extension across the blow-by fluid inlet channel 91. A tubular construction of media 112 forms a second stage filter 114 and extends between the first end cap 106 and second end cap 108. The tubular construction of media 112 defines an open tubular interior 116. The blow-by fluid inlet channel 91 is in flow communication with the open tubular interior 116. As can be seen, the inlet tube 190 is coaxial with and in fluid communication with the blow-by inlet channel 91.

In the embodiment shown, the tubular construction of media 112 of the second stage filter 114, the first end cap 106, the second end cap 108, and the first stage coalescer filter 110 are unitary in construction. As used herein, the term “unitary” means that the first stage filter 110 and second stage filter 114 cannot be separated from each other without destroying a portion of the element 96. When the filter element 96 is handled, for example, during servicing, both the first stage filter 110 and second stage filter 114 are handled together.

In the embodiment shown, the first stage coalescer filter includes a non-woven fibrous bundle 118 having a first upstream side 120. The upstream side 120 has a certain, defined surface area. The second stage filter 114 has an upstream side 122 that also defines an upstream surface area. In the particular embodiment illustrated, there is a relationship between the upstream side surface area 120 and the upstream side surface area 122 between the first stage coalescer filter 110 and the second stage filter 114. In useable embodiments, the first upstream surface area will be not more than 25% of the upstream surface area of the second stage filter 114. In many embodiments, this percentage will be not more than 10%, and in some cases, not more than 2%.

D. Example Methods

In operation, and in reference now to FIG. 2, methods of using the valve arrangement 40 are described. In use, blow-by fluid 38 is directed from the engine crankcase 30 through the blow-by inlet 90 of the housing 98. The valve arrangement 40 is operably installed therein such that the diaphragm 70 forms seal 72 with the housing 98. The seal 98 prevents blow-by fluid from exiting the housing 98 through the blow-by outlet channel 176, except when the relief aperture arrangement 50 is exposed.

In FIG. 2, it can be seen how there is a gap or space 194 between the second pressure receiving surface 64 of the piston head 54 and an end of the inlet tube 190. The spring 184 holds the piston head 54 away from the end of the inlet tube 190 to create the gap or space 194.

Blow-by fluid is allowed to flow into the housing 98 and into the blow-by inlet channel 91 by flowing through the space 194. The blow-by fluid 38 then flows into the two-stage element 96.

The first stage coalescer filter 110 functions to remove oil or other liquid from the blow-by fluid 38. The coalesced liquid exits the housing 98 through the liquid outlet 92. The remaining gas in the blow-by fluid 38 then flows around an end 123 of a central tube 124 and through the second stage 114 of tubular media 112. The tubular media 112 removes particulate matter from the gas. The clean gas then flows out of the housing 98 through the filtered gas port 94. From there, the filtered gas is directed back into the turbo 34 for use by the engine 30. Arrows 125 show the flow path of the fluid 38.

In use, the first biasing member 46 applies a force against the plate 44 to hold the plate 44 in moveable covering relation to the relief aperture arrangement 50. If the restriction across the blow-by filter member 95 increases to a certain level, there will be pressure exerted against the second pressure receiving surface of the piston head 54. The pressure will flow through the relief aperture arrangement 50 and contact the piston-head side 164 of the plate 44. When the pressure has a force that overcomes the force exerted on the plate 44 by the first biasing member 46, the plate 44 will move away from the first pressure receiving surface 62 of the piston head 54. This will flow to flow through the relief aperture arrangement 50 and exit the housing 98 through the blow-by outlet channel 176.

As crankcase pressures fluctuate, the pressures on the piston head 154 will cause the U-shaped flexible portion 82 of the diaphragm 70 to deflect. This will cause the one-piece piston-diaphragm member 42 to move in an axial motion, parallel to the central longitudinal axis 84 and the connecting rod 52. The fluctuations in the crankcase pressure will cause the space 194 between the second pressure receiving surface 64 and the end of the inlet tube 190 to either grow or shrink. This will help regulate the pressure level within the crankcase 30.

Typical operating pressures include, in general, −10 to +10 inches of water, typically, but as much as −30 to +30 inches of water. As the crankcase pressures fluctuate, the pressures on the piston head 154 will cause the diaphragm 70 to deflect. In typical operation, the space 194 between the second pressure receiving surface 64 and the end of the inlet tube 190 will remain open, growing or shrinking in volume. Typically, that space 194 will not be closed, unless there is a catastrophic event within the crankcase 30. The relief aperture arrangement 50 will be exposed when the pressure level within the crankcase achieves a certain predetermined amount. Typically, the pressure will be at a level of about 10 inches of water, before the relief aperture arrangement 50 is exposed to allow for the flow of blow-by fluid through the relief aperture arrangement 50 and exit through the blow-by outlet channel 176. In general, the pressure for allowing for the exposure of the relief aperture arrangement can be from +4 to +15 inches of water, depending upon the desired operating parameters.

1. A valve arrangement comprising:
(a) a one-piece piston-diaphragm member; the one-piece piston-diaphragm member including a connecting rod terminating at a piston head;
(i) the piston head defining oppositely disposed first and second pressure-receiving surfaces constructed and arranged to respond to pressure;
(ii) the piston head further defining a relief aperture arrangement extending between the oppositely disposed first and second pressure-receiving surfaces;
(iii) the one-piece piston-diaphragm member including an adapter with a diaphragm molded over the adapter;
(A) a diaphragm oriented to form a seal with a housing, when the valve arrangement is operably installed within a housing;
(b) a plate in movable covering relation to the relief aperture arrangement in the piston head; the plate forming a releasable seal arrangement with the relief aperture arrangement; and
(c) a first biasing member applying force against the plate to hold the plate in movable covering relation to the relief aperture arrangement.

2. A valve arrangement according to claim 1 wherein:
(a) the plate is oriented against the first pressure-receiving surface of the piston head; and
(b) the first biasing member comprises a spring oriented between and against a portion of the connecting rod and the plate.

3. A valve arrangement according to claim 2 further comprising:
(a) a second biasing member applying force against the second pressure-receiving surface of the piston head.

4. A valve arrangement according to claim 1 wherein:
(a) the diaphragm includes:
(i) a rounded edge along an outer periphery constructed and arranged to fit in sealing engagement with a housing; and
(ii) a U-shaped flexible portion extending from the rounded edge to the piston head;
(A) the U-shaped flexible portion flexing in response to pressure forces on the piston head to permit the one-piece piston-diaphragm member to move in a direction parallel to the connecting rod.

5. A valve arrangement according to claim 2 wherein:
(a) the relief aperture arrangement comprises an inner ring and an outer ring of spaced holes in the piston head.

6. A valve arrangement according to claim 5 wherein:
(a) the plate is ring-shaped with a central aperture, a piston-head side and an opposite spring-receiving side;
(i) the connecting rod penetrating the central aperture;
(b) the relief aperture arrangement being exposed to the piston-head side of the plate;
(i) the plate being movable away from and out of sealing engagement with the relief aperture arrangement in response to pressure forces on the piston-head side of the plate through the relief aperture arrangement.

7. A valve arrangement according to claim 6 wherein:
(a) the connecting rod includes an end surface with a radially extending flange.

8. A valve arrangement according to claim 7 wherein:
(b) the spring-receiving side of the plate defines a spring seat having an axially projecting surface;
(i) the spring being oriented between and against the radially extending flange and the spring seat.

9. A valve arrangement according to claim 3 wherein:
(a) the piston head defines an axially extending member with a groove in a radial surface of the axially extending member;
(i) the second biasing member including a portion held within the groove of the axially extending member.

10. A valve arrangement according to claim 1 wherein:
(a) the adapter comprises glass filled nylon;
(b) the plate comprises glass filled nylon; and
(c) the diaphragm comprises rubber.

11. A closed crankcase system comprising:
(a) an air filter;
(b) an engine in gas flow communication with the air filter; the engine having a crankcase producing blow-by fluid;
(c) a blow-by filtration system downstream of and in fluid communication with the engine crankcase;
(i) the blow-by filtration system having a housing with a blow-by fluid inlet, a liquid outlet, a filtered gas port, and a blow-by filter member;
(ii) the filtered gas port being in gas-flow communication with the engine; and
(d) a valve arrangement operably installed in the blow-by filtration system housing downstream of the blow-by fluid inlet; the valve arrangement comprising:
(i) a one-piece piston-diaphragm member; the one-piece piston-diaphragm member including a connecting rod terminating at a piston head;
(A) the piston head defining oppositely disposed first and second pressure-receiving surfaces constructed and arranged to respond to pressure;
(B) the piston head further defining a relief aperture arrangement extending between the oppositely disposed first and second pressure-receiving surfaces;
(C) the one-piece piston-diaphragm member including an adapter with a diaphragm molded over the adapter;
(1) a diaphragm forming a seal with the housing;
(ii) a plate in movable covering relation to the relief aperture arrangement in the piston head; the plate forming a releasable seal arrangement with the relief aperture arrangement;
(iii) a first biasing member applying force against the plate to hold the plate in movable covering relation to the relief aperture arrangement; and
(iv) a second biasing member applying force against the second pressure-receiving surface of the piston head to control a flow of blow-by fluid from the blow-by fluid inlet to the blow-by filter member.

12. A closed crankcase system according to claim 11 wherein:
(a) the blow-by filter member includes a first stage coalescer filter and a second stage gas filter.

13. A closed crankcase system according to claim 11 wherein:
(a) the housing further includes a blow-by relief outlet channel;
(b) the plate is ring-shaped with a central aperture, a piston-head side and an opposite spring-receiving side;
(i) the connecting rod penetrating the central aperture;
(c) the relief aperture arrangement being exposed to the piston-head side of the plate;
(i) the plate being movable away from and out of sealing engagement with the relief aperture arrangement in response to pressure forces on the piston-head side of the plate through the relief aperture arrangement to permit the flow of blow-by fluid through the relief aperture arrangement and out of the housing through the blow-by relief outlet channel.

14. A closed crankcase system according to claim 13 wherein:
(a) the diaphragm includes:
(i) a rounded edge along an outer periphery in sealing engagement with the housing; and
(ii) a U-shaped flexible portion extending from the rounded edge to the piston head;
(A) the U-shaped flexible portion flexing in response to pressure forces on the piston head to permit the piston to move in a direction parallel to the connecting rod.

15. A closed crankcase system according to claim 14 wherein:
(a) the housing defines an inlet tube with a collar;
(b) the piston head defines an axially extending member with a groove in a radial surface of the axially extending member;
(i) the second biasing member circumscribing the inlet tube; and
(ii) the second biasing member being oriented within the groove of the axially extending member and against the collar of the inlet tube.

16. A method for regulating pressure in a closed crankcase system; the method comprising:
(a) directing blow-by fluid from an engine crankcase to a valve arrangement; the valve arrangement comprising:
(i) a one-piece piston-diaphragm member; the one-piece piston-diaphragm member including a connecting rod terminating at a piston head;
(A) the piston head defining oppositely disposed first and second pressure-receiving surfaces constructed and arranged to respond to pressure caused by the blow-by fluid;
(B) the piston head further defining a relief aperture arrangement extending between the oppositely disposed first and second pressure-receiving surfaces;
(C) the one-piece piston-diaphragm member including an adapter with a diaphragm molded over the adapter;
(ii) a plate in movable covering relation to the relief aperture arrangement in the piston head; the plate forming a releasable seal arrangement with the relief aperture arrangement;
(b) controlling flow of blow-by fluid through the relief aperture arrangement by applying force against the plate to hold the plate in movable covering relation to the relief aperture arrangement; and
(c) controlling flow of the blow-by fluid to downstream components by applying force against the second pressure-receiving surface of the piston head.

17. A method according to claim 16 wherein:
(a) the step of controlling flow of blow-by fluid through the relief aperture arrangement includes using a first spring oriented between the plate and a portion of the connecting rod to bias the plate in covering relation to the relief aperture arrangement.

18. A method according to claim 17 wherein:
(a) the step of controlling flow of the blow-by fluid to downstream components includes using a second spring to apply force against the second pressure-receiving surface of the piston head to control a flow of blow-by fluid to downstream components.

19. A method according to claim 18 wherein:
(a) the step of using a second spring to apply force against the second pressure-receiving surface of the piston head to control a flow of blow-by fluid to downstream components includes controlling a flow of blow-by fluid to a first stage coalescer filter and a second stage gas filter.
